(19) United States
(12) Patent Application Publication
(10) Pub. No.: US 2012/0183040 A1
(43) Pub. Date: Jul. 19, 2012

(54) Dynamic Video Switching

(75) Inventors: Xin Fang, Raleigh, NC (US); Wei Shi, Cary, NC (US); Gerald Paul Michalak, Cary, NC (US)

(73) Assignee: QUALCOMM INCORPORATED, San Diego, CA (US)

(21) Appl. No.: 13/009,083

(22) Filed: Jan. 19, 2011

(51) Int. Cl. H04N 7/26

(52) U.S. Cl. 375/240.02; 375/E07.026

(57) ABSTRACT

In an example, a dynamic codec allocation method is provided. The method includes receiving a plurality of datastreams and determining a respective codec loading factor for each of the datastreams. The datastreams are assigned to codecs, in order by respective codec loading factor, starting with the highest respective codec loading factor. Initially, the datastreams are assigned to a hardware codec, until the hardware codec is loaded to substantially maximum capacity. If the hardware codec is loaded to substantially maximum capacity, the remaining datastreams are assigned to a software codec. As new datastreams are received, the method repeats, and previously-assigned datastreams can be reassigned from a hardware codec to a software codec, and vice versa, based on their relative codec loading factors.

### FIELD OF DISCLOSURE

The present disclosure relates generally to communications, and more specifically, but not exclusively, to methods and apparatus for dynamic video switching.

### BACKGROUND

The market demands devices that can simultaneously decode multiple datastreams, such as audio and video datastreams. Video datastreams contain a large quantity of data, thus, prior to transmission, video data is compressed to efficiently use a transmission media. Video compression efficiently codes video data into streaming video formats. Compression converts the video data to a compressed bit stream format having fewer bits, which can be transmitted efficiently. The inverse of compression is decompression, also known as decoding, which produces a replica (or a close approximation) of the original video data.

A codec is a device that codes and decodes the compressed bit stream. Using a hardware decoder is preferred over using a software decoder, due to reasons such as performance, power consumption and alternate usage for processor cycles. Accordingly, certain decoder types are preferred over other decoder types, regardless of whether the decoder is comprised of block of gates, a central processing unit (CPU), a graphics processing unit (GPU), a digital signal processor (DSP), or combination of these elements.

Referring to FIG. 1, when two or more encoded datastreams are input to a conventional device, a first-come, first serve, conventional assignment model 100 assigns the incoming datastreams to available codecs when a video event occurs. A video event triggers the first-come, first serve, conventional assignment model 100. For example, a video event can be one or more processes relating to a video stream, such as starting, finishing, pausing, resuming, seeking, and/or changing resolution. In the example of FIG. 1, only one hardware codec is available. The first received datastream is video1 105, which is assigned to a hardware video codec. A second datastream, video2 110, is subsequently received, and because no hardware codec is available, is assigned to a software codec. Subsequently received datastreams are also assigned to a software codec, as the sole hardware codec is preoccupied with processing video1 105. In the conventional assignment model 100, once a datastream is assigned to a codec, it is not reassigned to a different codec. Thus, once assigned to a software codec, video2 110 and subsequent datastreams are not assigned to the hardware codec, even if the hardware codec stops processing video1 105.

The conventional assignment model 100 is simple, and not optimal. Hardware codecs can very quickly and efficiently decode complex encoding schemes (e.g., MPEG-4), while relatively simpler coding schemes (e.g., H.261) can be quickly and efficiently decoded by both hardware codecs and software codecs. However, the conventional assignment model 100 does not intentionally assign a datastream to the type of codec (hardware or software) that can most efficiently decode the datastream. Referring again to FIG. 1, if video1 105 has a simple coding scheme, and video2 110 has a complex coding scheme, then the capabilities of the hardware codec are underutilized to decode video1 105, while the processor labors to decode video2 110. A user viewing video1 and video2 110 experiences a decoded version of video1 105 that is satisfactory, while video2 110, which the user expects to provide higher performance than video1 105 because of video2's 110 complex coding scheme, may contain artifacts, lost frames, and quantization noise. Thus, the conventional assignment model 100 wastes resources, is inefficient, and provides users with substandard results.

Accordingly, there are industry needs for methods and apparatus to address the aforementioned concerns.

### SUMMARY

Exemplary embodiments of the invention are directed to systems and methods for dynamic video switching.

In an example, a dynamic codec allocation method is provided. The method includes receiving a plurality of datastreams and determining a respective codec loading factor for each of the datastreams. The datastreams are assigned to codecs, in order by respective codec loading factor, starting with the highest respective codec loading factor. Initially, the datastreams are assigned to a hardware codec, until the hardware codec is loaded to substantially maximum capacity. If the hardware codec is loaded to substantially maximum capacity, the remaining datastreams are assigned to a software codec. As new datastreams are received, the method repeats, and previously-assigned datastreams can be reassigned from a hardware codec to a software codec, and vice versa, based on the datastream's relative codec loading factors.

In a further example, a dynamic codec allocation apparatus is provided. The dynamic codec allocation apparatus includes means for receiving a plurality of datastreams and means for determining a respective codec loading factor for each datastream in the plurality of datastreams. The dynamic codec allocation apparatus also includes means for assigning the datastreams to a hardware codec, in order by respective codec loading factor starting with the highest respective codec loading factor, until the hardware codec is loaded to substantially maximum capacity and means for assigning the remaining datastreams to a software codec, if the hardware codec is loaded to substantially maximum capacity.

In another example, a non-transitory computer-readable medium is provided. The non-transitory computer-readable medium comprises instructions stored thereon that, if executed by a processor, cause the processor to execute a dynamic codec allocation method. The dynamic codec allocation method includes receiving a plurality of datastreams and determining a respective codec loading factor for each of the datastreams. The datastreams are assigned to codecs, in order by respective codec loading factor, starting with the highest respective codec loading factor. Initially, the datastreams are assigned to a hardware codec, until the hardware codec is loaded to substantially maximum capacity. If the hardware codec is loaded to substantially maximum capacity, the remaining datastreams are assigned to a software codec. As new datastreams are received, the method repeats, and previously-assigned datastreams can be reassigned from a hardware codec to a software codec, and vice versa, based on the datastream's relative codec loading factors.

In a further example, a dynamic codec allocation apparatus is provided. The dynamic codec allocation apparatus includes a hardware codec and a processor coupled to the hardware codec. The processor is configured to receive a plurality of datastreams, determine a respective codec loading factor for each datastream in the plurality of datastreams, assign the datastreams to the hardware codec, in order by respective codec loading factor starting with the highest respective codec loading factor, until the hardware codec is loaded to substantially maximum capacity, and if the hardware codec is loaded to substantially maximum capacity, assign the remaining datastreams to a software codec.

Other features and advantages are apparent in the appended claims, and from the following detailed description.

### BRIEF DESCRIPTION OF THE DRAWINGS

The accompanying drawings are presented to aid in the description of embodiments of the invention, and are provided solely for illustration of the embodiments and not limitation thereof.

FIG. 1 depicts a conventional assignment model.

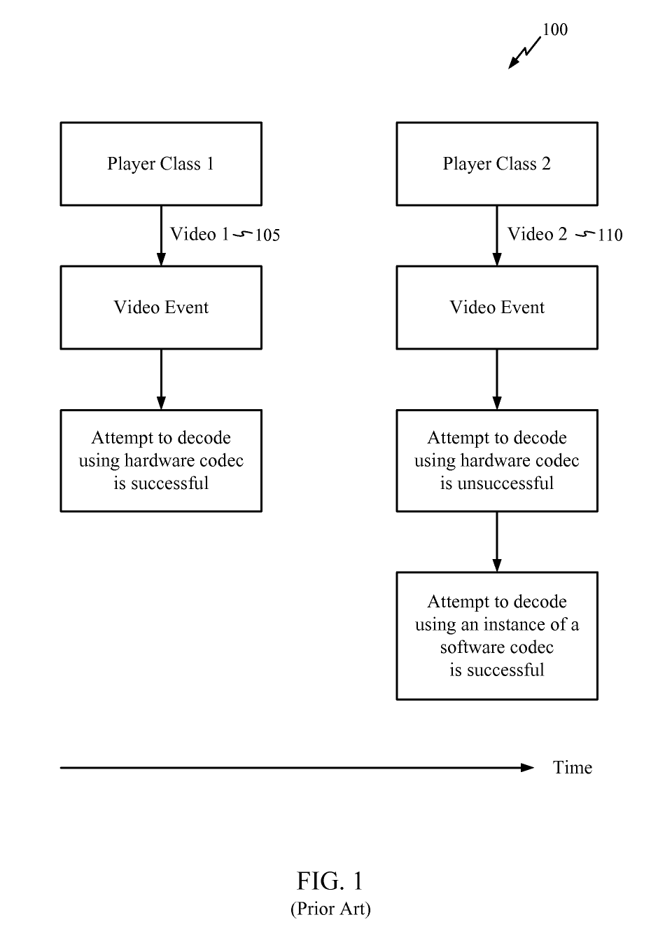

FIG. 2 depicts an exemplary communication device.

FIG. 3 depicts a working flow of an exemplary dynamic video switching device.

FIG. 4 depicts an exemplary table of video stream information.

FIG. 5 depicts a flowchart of an exemplary method for dynamically assigning a codec.

FIG. 6 depicts a flowchart of another exemplary method for dynamically assigning a codec.

FIG. 7 depicts a flowchart of a further exemplary method for dynamically assigning a codec.

FIG. 8 depicts an exemplary timeline of a dynamic video switching method.

FIG. 9 is a pseudocode listing of an exemplary dynamic video switching algorithm.

In accordance with common practice, some of the drawings are simplified for clarity. Thus, the drawings may not depict all of the components of a given apparatus (e.g., device) or method. Finally, like reference numerals are used to denote like features throughout the specification and figures.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. For example, references hereby to a hardware codec also are intended to refer to a plurality of hardware codecs. As a further example, references hereby to a software codec also are intended to refer to a plurality of software codecs. Also, the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), encoders, decoders, codecs, by program instructions being executed by one or more processors, or by a combination thereof. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

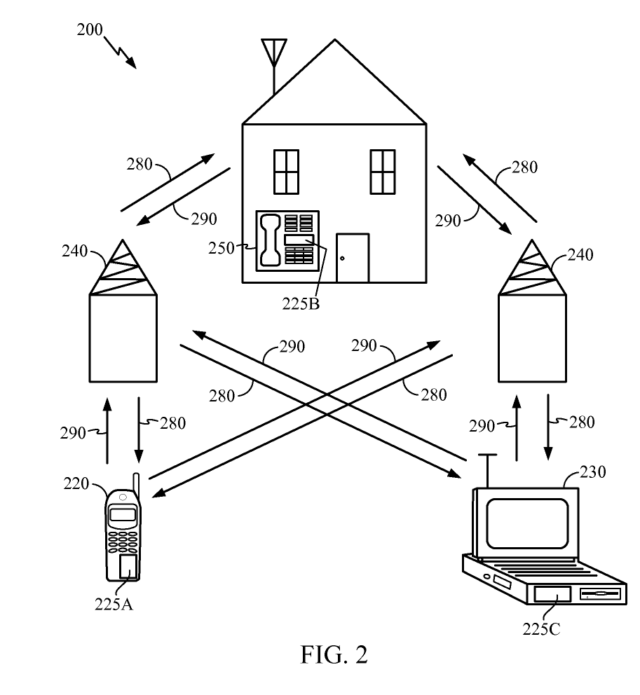

FIG. 2 depicts an exemplary communication system 200 in which an embodiment of the disclosure may be advantageously employed. For purposes of illustration, FIG. 2 shows three remote units 220, 230, and 250 and two base stations 240. It will be recognized that conventional wireless communication systems may have many more remote units and base stations. The remote units 220, 230, and 250 include at least a part of an embodiment 225A-C of the disclosure as discussed further below. FIG. 2 shows forward link signals 280 from the base stations 240 and the remote units 220, 230, and 250, as well as reverse link signals 290 from the remote units 220, 230, and 250 to the base stations 240.

In FIG. 2, the remote unit 220 is shown as a mobile telephone, the remote unit 230 is shown as a portable computer, and the remote unit 250 is shown as a fixed location remote unit in a wireless local loop system. For example, the remote units may be mobile phones, hand-held personal communication systems (PCS) units, portable data units such as personal data assistants, navigation devices (such as GPS enabled devices), set top boxes, music players, video players, entertainment units, fixed location data units (e.g., meter reading equipment), or any other device that stores or retrieves data or computer instructions, or any combination thereof. Although FIG. 2 illustrates remote units according to the teachings of the disclosure, the disclosure is not limited to these exemplary illustrated units. Embodiments of the disclosure may be suitably employed in any device.

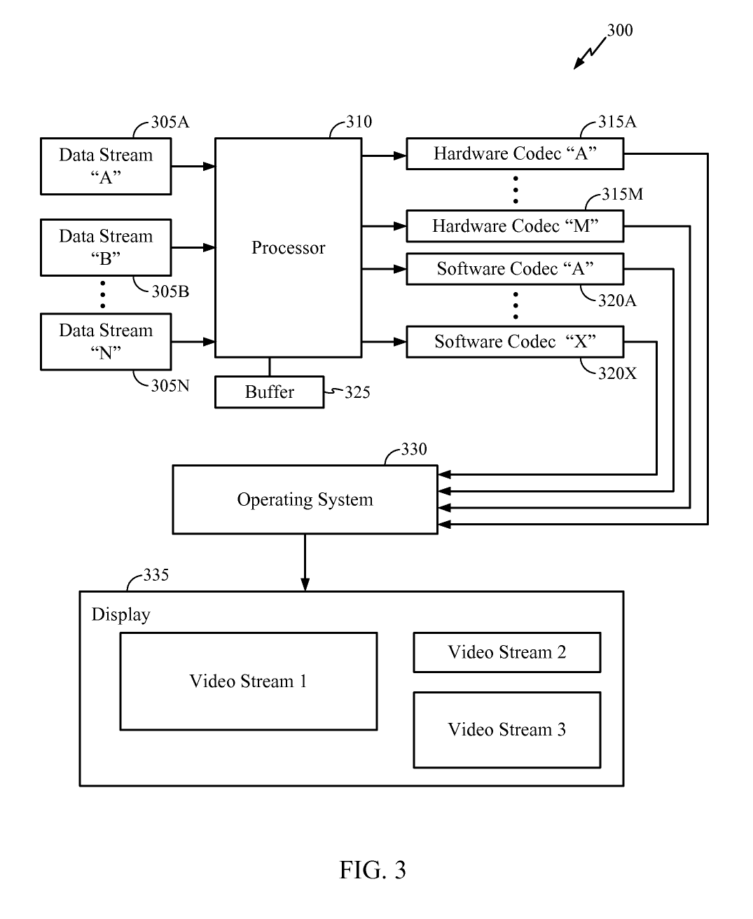

FIG. 3 depicts a working flow of an exemplary dynamic video switching device 300. At least two datastreams 305A-N are input to a processor 310, such as a routing function block. The datastreams 305A-N can be an audio datastream, video datastream, or a combination of both. The processor 310 is configured to perform at least a part of a method described hereby, and can be a central processing unit (CPU). For example, the processor can determine a respective codec loading factor (m_codecLoad) for each of the datastreams 305A-N. The datastreams 305A-N are assigned to at least one hardware codec 315A-M, in order by respective codec loading factor starting with the highest respective codec loading factor, until the hardware codec 315A-M is loaded to substantially maximum capacity. Assigning the datastreams 305A-N to the hardware codec 315A-M reduces a CPU's load and power consumption. If the hardware codec 315A-M is loaded to substantially maximum capacity, the remaining datastreams 305A-N are assigned to at least one software codec 320A-X. In examples, the software codec 320A-X can be programmable blocks, such as CPU-based, GPU-based, or DSP-based blocks. As new datastreams are received, the method repeats, and previously-assigned datastreams 305A-N can be reassigned from the hardware codec 315A-M to the software codec 320A-X, and vice versa, based on their relative codec loading factors.

The hardware codec 315A-M and the software codec 320A-X can be audio codecs, video codecs, and/or a combination of both. The hardware codec 315A-M and the software codec 320A-X can also be configured to not share resources, such as a memory. Alternatively, in some applications, the codecs described hereby are replaced by decoders. Using a hardware decoder is preferred over using a software decoder, due to reasons such as performance, power consumption and alternate usage for processor cycles. Accordingly, certain decoder types are preferred over other decoder types, regardless of whether the decoder has a block of gates, a central processing unit (CPU), a graphics processing unit (GPU), a digital signal processor (DSP), or combination of these elements.

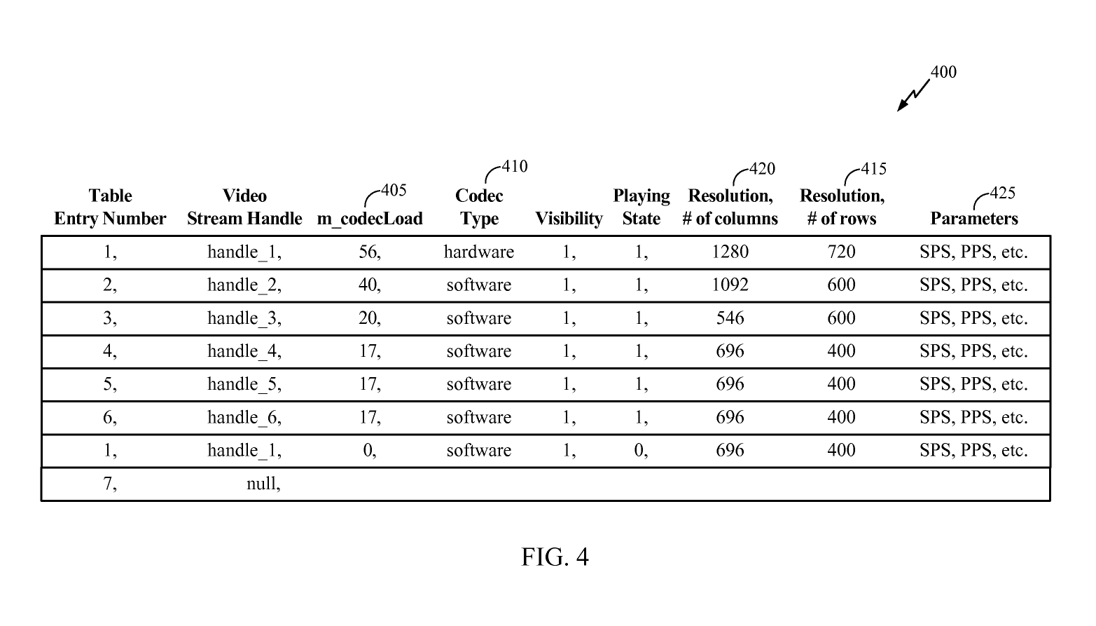

The processor 310 can be coupled to a buffer 325, which buffers the data in the datastreams 305A-N during codec assignment and reassignment. The buffer 325 can also store information describing parameters of the datastreams 305A-N, to be used in the event of codec reassignment. An exemplary table of video stream information 400 is depicted in FIG. 4.

The outputs from the hardware codec 315A-M and the software codec 320A-X are input to an operating system 330, which interfaces the hardware codec 315A-M and the software codec 320A-X with a software application and/or hardware that uses, displays, and/or otherwise presents the information carried by in the datastreams 305A-N. The operating system 330 and/or software application can instruct a display 335 to simultaneously display video data from the datastreams 305A-N.

FIG. 4 depicts an exemplary table of video stream information 400. The table of video stream information 400 includes a respective loading factor (m_codecLoad) 405 for each received datastream, as well as other information, such as codec type currently assigned 410, resolution rows 415, resolution columns 420, as well as other parameters 425, such as bit stream header information, sequence parameter set (SPS), and picture parameter set (PPS). The table of video stream information 400 is sorted from highest loading factor 405 to lowest loading factor 405.

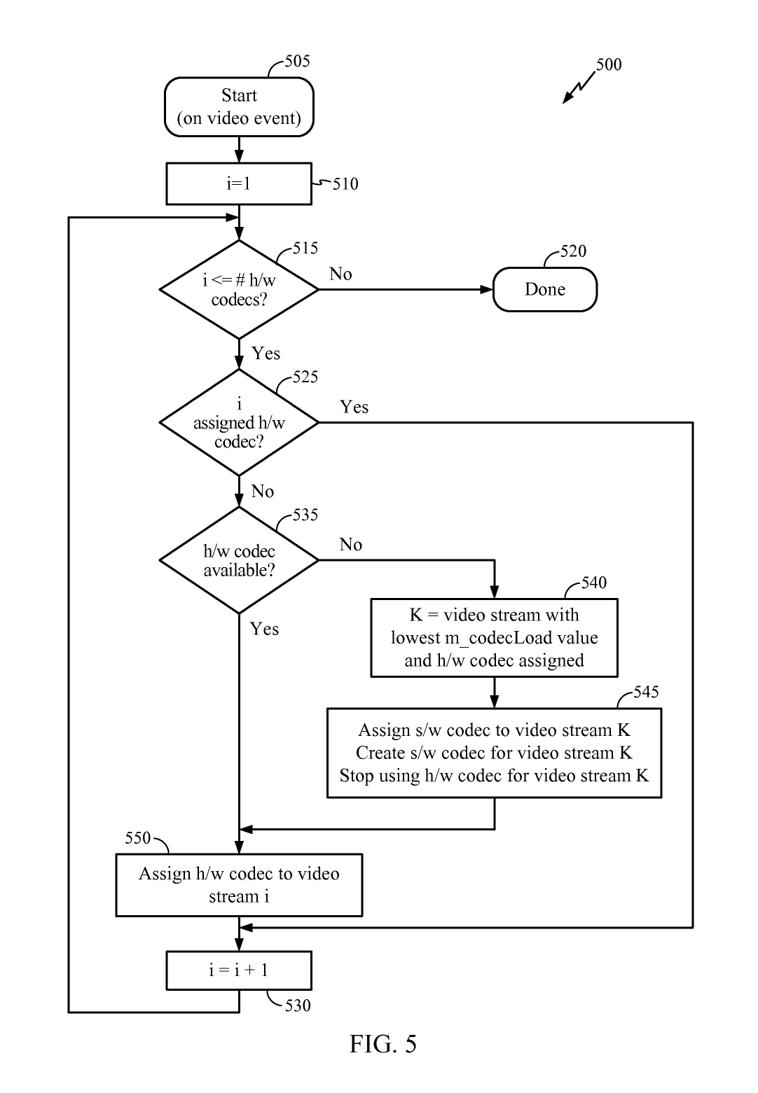

FIG. 5 depicts a flowchart of an exemplary method for dynamically assigning codecs 500.

In step 505, the method 500 for dynamically assigning codecs starts on receipt of a video datastream.

In step 510, referring to the table 400, the table index “i” is set to one.

In step 515, a first determination is made. If “i” is not less than, or equal to, the number of hardware codecs, then step 520 is executed, which ends the method. If “i” is less than, or equal to, the number of hardware codecs, then step 525 is executed.

In step 525, a second determination is made. If the datastream corresponding to table entry “i” is assigned a hardware codec, then the method proceeds to step 530, else step 535 is executed.

In step 530, a value of one is added to the table entry number “i”, and step 515 is repeated.

In step 535, a third determination is made. If a hardware codec is not available, then the method proceeds to step 540, else step 550 is executed.

In step 540, a table entry number “K”, representing the datastream having the lowest codec loading factor and a hardware codec assigned is identified.

In step 545, a software codec is created and assigned for datastream “K”, and datastream “K” stops using the hardware codec. The method then proceeds to step 550.

In step 550, the available hardware codec is assigned to datastream “i”. The method then repeats step 530. The method of FIG. 5 is not the sole method for dynamically assigning codecs.

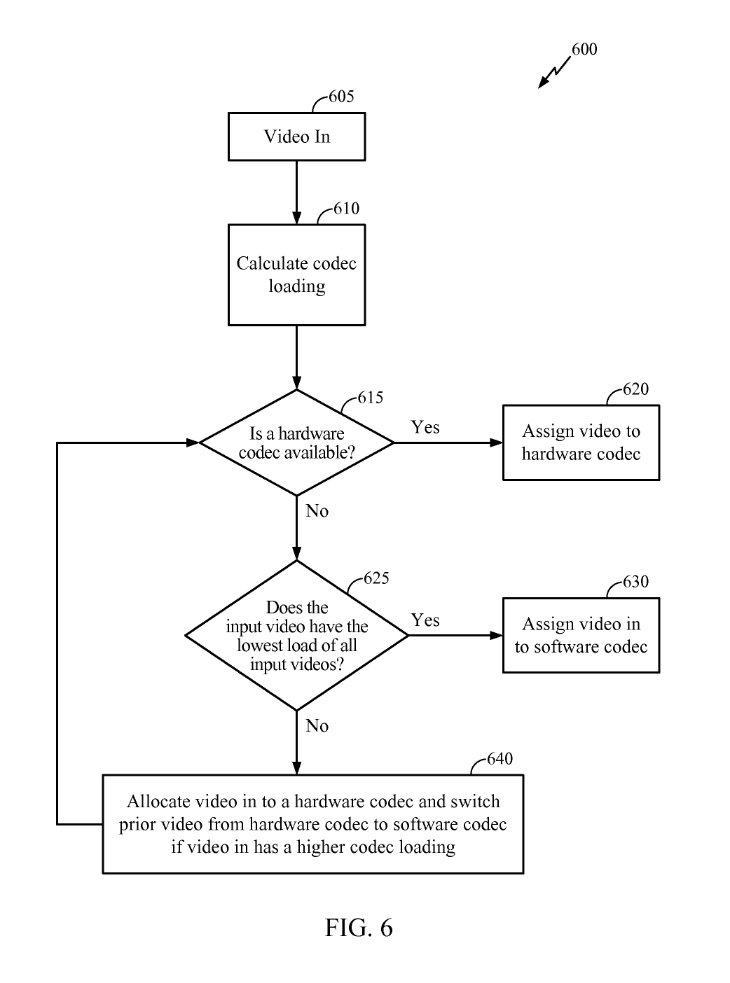

FIG. 6 depicts a flowchart of another exemplary method for dynamically assigning a codec 600.

In step 605, the method for dynamically assigning a codec 600 starts on receipt of a video datastream.

In step 610, a codec loading factor (m_codecLoad) is calculated for the received video datastream.

In step 615, a determination is made. If a hardware codec is available, the method proceeds to step 620, where the received video datastream is assigned to a hardware codec. Otherwise, the method proceeds to step 625.

In step 625, a decision is made. If the received video datastream has the lowest loading factor of all input datastreams, including previously-input datastreams, then the method proceeds to step 630, where the received video datastream is assigned to a software codec. If the received video datastream does not have the lowest codec loading factor of all input videos, including previously-input datastreams, then the method proceeds to step 640.

In step 640, the received video datastream is assigned to a hardware codec. A different video datastream previously assigned to the hardware codec can be reassigned to a software codec if the received video datastream has a higher codec loading factor than the previously assigned video datastream.

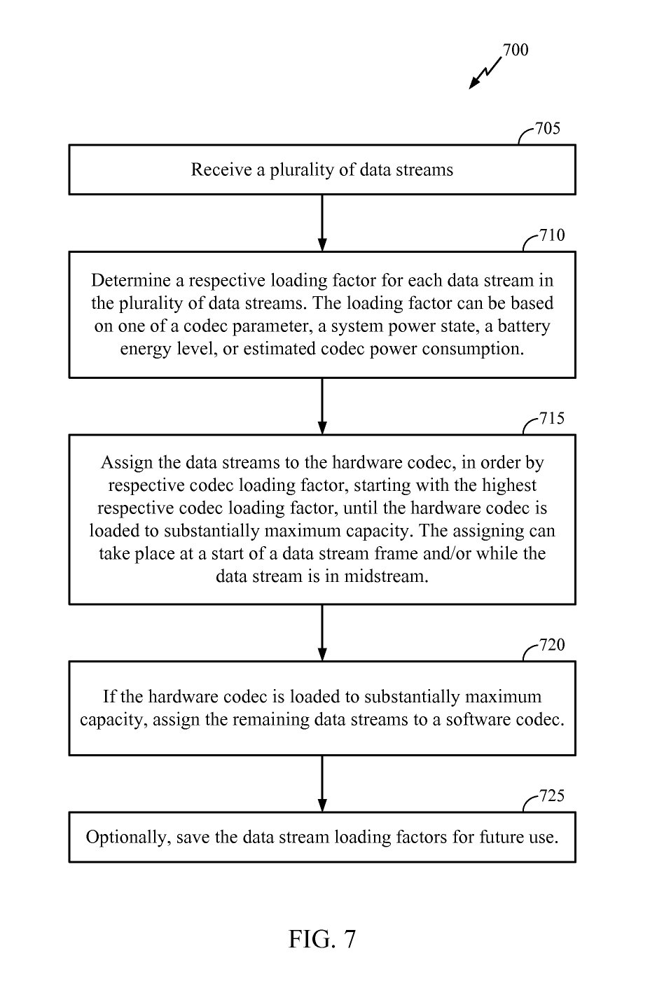

FIG. 7 depicts a flowchart of an exemplary method for dynamically assigning codecs 700.

In step 705, a plurality of datastreams is received.

In step 710, a respective codec loading factor (m_codecLoad) is determined for each datastream in the plurality of datastreams. The codec loading factor can be based on a codec parameter, a system power state, a battery energy level, and/or estimated codec power consumption. The codec loading factor can also be based on datastream resolution, visibility on a display screen, play/pause/stop status, entropy coding type, as well as video profile and level values. One equation to determine the codec loading factor is:

m_codecLoad=((video width*video height)>>14)*Visible on display*Playing

where “Visible on display” is set to logic one if any of the respective video is visible on a display screen, else it is set to logic zero. “Playing” is set to logic one if the respective video is playing, else it is set to logic zero.

In step 715, the datastreams are assigned to the hardware codec in order by respective codec loading factor, starting with the highest respective codec loading factor, until the hardware codec is loaded to substantially maximum capacity. The assigning can take place at a start of a datastream frame and/or while the datastream is in mid-stream.

In step 720, if the hardware codec is loaded to substantially maximum capacity, the remaining datastreams are assigned to a software codec.

In step 725, the datastream loading factors are optionally saved for future use.

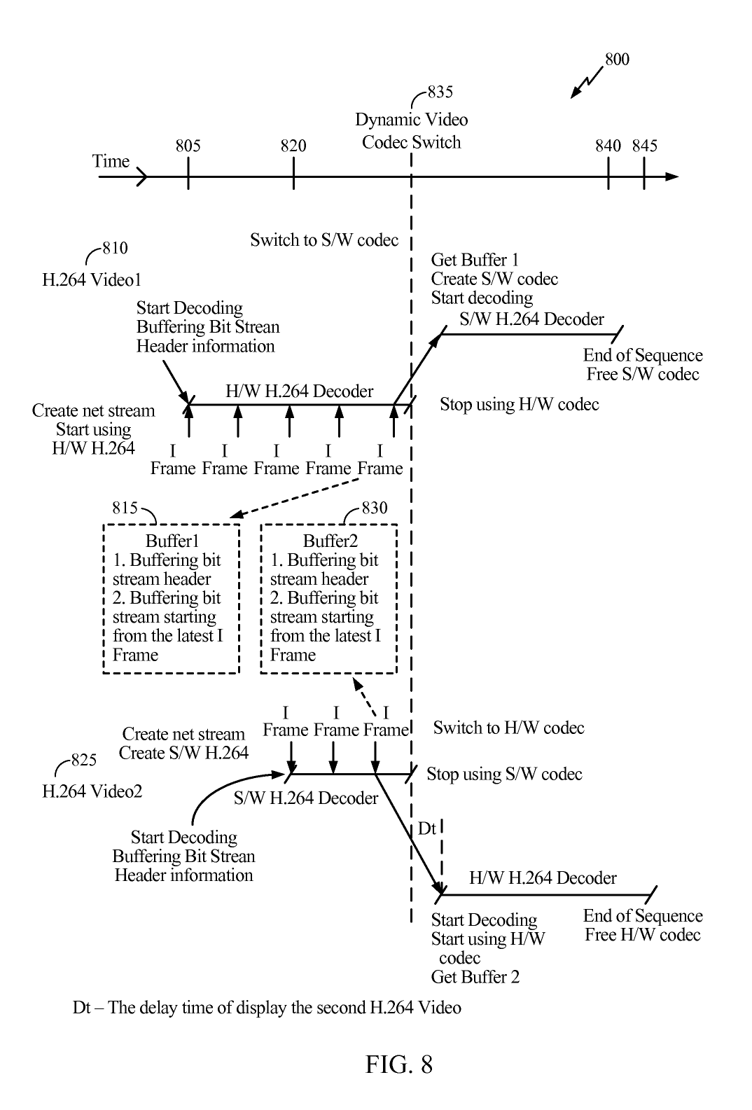

FIG. 8 depicts an exemplary timeline 800 of a dynamic video switching method. The timeline 800 shows how a first video datastream having a low codec loading factor is reassigned from a hardware codec to a software codec when a second video datastream having a relatively higher codec loading factor is subsequently received. The steps of the method described by the timeline 800 can be performed in any operative order.

At time one 805, a first video datastream 810 having H.264 coding is received. A respective codec loading factor (m_codecLoad) is determined for the first video datastream 810. The first video datastream 810 is assigned to a hardware codec, buffered in a first buffer 815, and decoding starts.

At time two 820, a second video datastream 825 having H.264 coding is received. A respective codec loading factor (m_codecLoad) is determined for the second video datastream 825. In this example, the codec loading factor is higher for the second video datastream 825 than for the first video datastream 810. An instance of a software codec is created for the second video datastream 825. The second video datastream 825 is assigned to the software codec, and buffered in a second buffer 830.

At time three 835, the first video datastream 810 is reassigned to a software codec and the second video datastream 825 is reassigned to the hardware codec, based on the relative values of the codec loading factors for the first video datastream 810 and the second video datastream 825. The reassignment can be automatic, can be performed at a hardware layer, and does not require any action by the end user. At, or after time three 835, an instance of a software codec is created for the first video datastream 810, the buffered version of the first video datastream 815 is input to the software codec, and the first video datastream 810 is decoded. The time at which software decoding of the first video datastream 810 starts can be simultaneous with a start of a key frame from the first video datastream 810. The first video datastream 810 also stops using the hardware codec. Additionally at, or after time three 835, the second video datastream 825 stops using the second video datastream's 825 respective software codec, and starts decoding the buffered version of the second video datastream 825 from the second buffer, using the hardware codec. The time at which decoding of the second video datastream 825 starts can be simultaneous with a start of a key frame from the second video datastream 825. There is a time delay (Dt) between time three and the start of the decoding of the buffered version of the second video datastream 825. In an example, the Dt is so short as to be imperceptible by a viewer of the first video datastream 810 and the second video datastream 825. In additional examples, there is a minor pause or corruption of the decoded video at the time of switching.

At time four 840, the first video datastream 810 ceases, and the instance of the first video datastream's 810 respective software codec stops. At time five 845, the second video datastream 825 ceases, and the second video datastream's 825 use of the hardware codec stops.

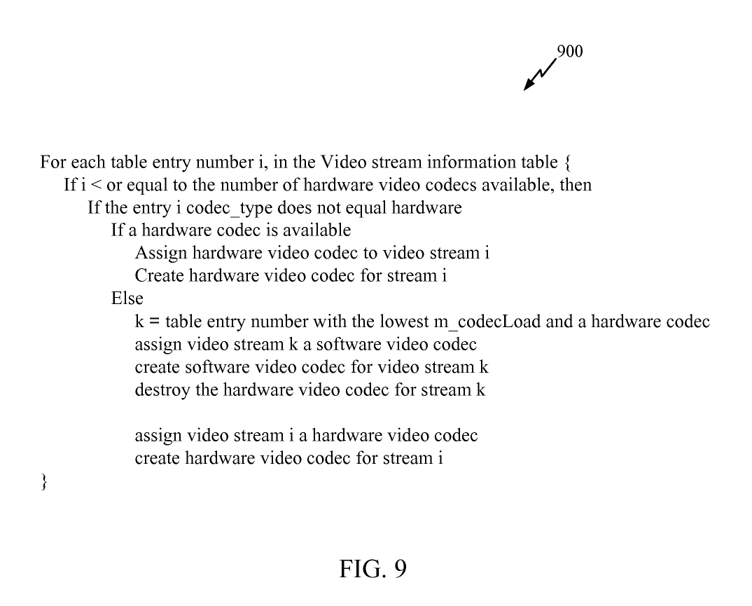

The dynamic assignment methods are applicable to both encoding and decoding processes. FIG. 9 is a pseudocode listing of an exemplary dynamic video switching algorithm 900, which describes a method for dynamic video switching.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for dynamic video switching. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A dynamic codec allocation method, comprising:
receiving a plurality of datastreams;
determining a respective codec loading factor for each datastream in the plurality of datastreams;
assigning the datastreams to a hardware codec, in order by respective codec loading factor starting with the highest respective codec loading factor, until the hardware codec is loaded to substantially maximum capacity; and
if the hardware codec is loaded to substantially maximum capacity, assigning the remaining datastreams to a software codec.

2. The method of claim 1, further comprising saving the datastream loading factors for future use.

3. The method of claim 1, wherein at least one of the assigning the datastreams to a hardware codec or the assigning the remaining datastreams to a software codec is performed at a start of a datastream frame.

4. The method of claim 1, wherein the assigning the datastreams to a hardware codec is performed on a datastream in the plurality of datastreams while the datastream is in mid-stream.

5. The method of claim 1, wherein the determining the respective codec loading factor is based at least on one of a codec parameter, a system power state, a battery energy level, or estimated codec power consumption.

6. The method of claim 1, wherein the determining the respective codec loading factor and the assigning the datastreams to a hardware codec are triggered by a video event.

7. A dynamic codec allocation apparatus, comprising:
means for receiving a plurality of datastreams;
means for determining a respective codec loading factor for each datastream in the plurality of datastreams;
means for assigning the datastreams to a hardware codec, in order by respective codec loading factor starting with the highest respective codec loading factor, until the hardware codec is loaded to substantially maximum capacity; and
means for assigning the remaining datastreams to a software codec, if the hardware codec is loaded to substantially maximum capacity.

8. The apparatus of claim 7, further comprising means for saving the datastream loading factors for future use.

9. The apparatus of claim 7, wherein at least one of the means for assigning the datastreams to a hardware codec or the means for assigning the remaining datastreams to a software codec, includes means for performing the respective assigning at a start of a datastream frame.

10. The apparatus of claim 7, wherein the means for assigning the datastreams to a hardware codec includes means for assigning a datastream in the plurality of datastreams while the datastream is in mid-stream.

11. The apparatus of claim 7, wherein the means for determining the respective codec loading factor include means for determining the respective codec loading factor based at least on one of a codec parameter, a system power state, a battery energy level, or estimated codec power consumption.

12. The apparatus of claim 7, wherein the means for determining the respective codec loading factor and the means for assigning the datastreams to a hardware codec are triggered by a video event.

13. A non-transitory computer-readable medium, comprising instructions stored thereon that, if executed by a processor, cause the processor to execute a method comprising:
receiving a plurality of datastreams;
determining a respective codec loading factor for each datastream in the plurality of datastreams;
assigning the datastreams to a hardware codec, in order by respective codec loading factor starting with the highest respective codec loading factor, until the hardware codec is loaded to substantially maximum capacity; and
if the hardware codec is loaded to substantially maximum capacity, assigning the remaining datastreams to a software codec.

14. The non-transitory computer-readable medium of claim 13, wherein the method further comprises saving the datastream loading factors for future use.

15. The non-transitory computer-readable medium of claim 13, wherein at least one of the assigning the datastreams to a hardware codec or the assigning the remaining datastreams to a software codec is performed at a start of a datastream frame.

16. The non-transitory computer-readable medium of claim 13, wherein the assigning the datastreams to a hardware codec is performed on a datastream in the plurality of datastreams while the datastream is in mid-stream.

17. The non-transitory computer-readable medium of claim 13, wherein the determining the respective codec loading factor is based at least on one of a codec parameter, a system power state, a battery energy level, or estimated codec power consumption.

18. The non-transitory computer-readable medium of claim 13, wherein the determining the respective codec loading factor and the assigning the datastreams to a hardware codec are triggered by a video event.

19. A dynamic codec allocation apparatus, comprising:
a hardware codec; and
a processor coupled to the hardware codec, and configured to:
receive a plurality of datastreams;
determine a respective codec loading factor for each datastream in the plurality of datastreams;
assign the datastreams to the hardware codec, in order by respective codec loading factor starting with the highest respective codec loading factor, until the hardware codec is loaded to substantially maximum capacity; and
if the hardware codec is loaded to substantially maximum capacity, assign the remaining datastreams to a software codec.

20. The apparatus of claim 19, further comprising a memory coupled to the processor, and configured to save the datastream loading factors for future use.

21. The apparatus of claim 19, wherein the processor is further configured to, at a start of a datastream frame, perform at least one of the assigning the datastreams to a hardware codec or assigning the remaining datastreams to a software codec.

22. The apparatus of claim 19, wherein the processor is configured to perform the assigning the datastreams to a hardware codec on a datastream in the plurality of datastreams while the datastream is in mid-stream.

23. The apparatus of claim 19, wherein the processor is configured to determine the respective codec loading factor based at least on one of a codec parameter, a system power state, a battery energy level, or estimated codec power consumption.

24. The apparatus of claim 19, wherein the processor is configured to determine the respective codec loading factor and the assign the datastreams to a hardware codec when triggered by a video event.
